(19) United States
(12) Patent Application Publication
(10) Pub. No.: US 2026/0210204 A1
(43) Pub. Date: Jul. 23, 2026

(54) METHOD OF USING STEEL-PRODUCTION BYPRODUCT HEAVY AGENT IN SUBTERRANEAN FORMATION FLUIDS

(71) Applicant: King Fahd University of Petroleum and Minerals, Dhahran (SA)

(72) Inventors: Jaber AL JABERI, Al Khober (SA); Badr BAGERI, Dhahran (SA)

(73) Assignee: King Fahd University of Petroleum and Minerals, Dhahran (SA)

(21) Appl. No.: 19/457,891

(22) Filed: Jan. 23, 2026

Related U.S. Application Data
(60) Provisional application No. 63/748,790, filed on Jan. 23, 2025.

(51) Int. Cl. E21B 33/138; C04B 18/14; C09K 8/16; C09K 8/48

(52) U.S. Cl. CPC E21B 33/138; C04B 18/149; C09K 8/16; C09K 8/48

(57) ABSTRACT

A method includes providing a fluid including a heavy agent steel production byproduct. The heavy agent steel production byproduct includes calcium in an amount of 10 to 50 percent by weight (wt. %), iron in an amount of 8 to 25 wt. %, aluminum in an amount of 2 to 5 wt. %, magnesium in an amount of 1 to 5 wt. %, and silicon in an amount of 1 to 4 wt. % based on a total weight of the heavy agent steel production byproduct. The heavy agent steel production byproduct has a particle size distribution D₅₀ value of 10 to 110 μm. The method further includes introducing the fluid into a subterranean formation through tubing disposed in a wellbore.

### STATEMENT REGARDING PRIOR DISCLOSURE BY THE INVENTORS

Aspects of the present disclosure are described in Al Jaberi, J. et al., “Repurposing steel byproducts for sustainable utilization as a novel weighting agent in drilling fluids” published in Volume 432, Journal of Molecular Liquids (2025), which is incorporated herein by reference in its entirety.

### CROSS REFERENCE TO RELATED APPLICATION

This application claims the benefit of U.S. Provisional Application No. 63/748,790, filed Jan. 23, 2025, which is incorporated herein by reference in its entirety.

### BACKGROUND

### Technical Field

The present disclosure relates to drilling fluid and cementing technologies for oil and gas well construction. Specifically, the disclosure relates to the utilization of steel-production heavy agents (HASPB-1 and HASPB-2) as densifying and bridging materials for deep and ultra-deep well applications.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

Drilling and cementing operations use various additives to enable safe and efficient penetration of subterranean formations. Among these additives, weighting materials play a role in controlling fluid density. In drilling operations, density control is used to prevent formation fluid influxes, commonly referred to as kicks, while in cementing operations, appropriate density is used to stabilize unstable boreholes, counter high formation pressures, and manage deformable or weak formations [Ahmed, A., et al., The effect of weighting materials on oil well cement properties while drilling deep wells, Sustainability (Switzerland), 11, 2019; and Ahmed, A., et al., Influence of weighting materials on the properties of oil-well cement, ACS Omega, 5, 2020, 27618-27625]. These functions have become increasingly used in deep and ultra-deep wells, where harsh temperature and pressure conditions elevate operational risks, including the risk of blowouts.

Barite is the most widely used weighting material in drilling fluids owing to its relatively high specific gravity, chemical inertness, widespread availability, and comparatively low cost [Bageri, B. S., et al., Single stage filter cake removal of barite weighted water-based drilling fluid, Journal of Petroleum Science and Engineering, 149, 2017, 476-484]. With the increasing global demand for energy and the trend toward drilling deeper and more complex wells, the availability of high-quality barite suitable for drilling applications is expected to become increasingly constrained. In addition, barite resources are geographically limited, resulting in higher transportation costs and supply chain vulnerabilities [Omoniyi, O. A., et al., Potential usage of local weighting materials in drilling fluid as a substitute to barite, International Journal of Innovative Research and Development, 2014]. Consequently, barite prices are expected to increase, driving the need for alternative weighting materials.

Over the years, several alternative weighting agents have been proposed, including ilmenite, hematite, magnetite, galena, stibnite, and other high-density minerals [Almutawa, W., et al., Investigation of magnetite-based invert emulsion mud at high pressure high temperature, Arabian Journal of Geosciences, 14, -, 2021, 1-8; Gross, H., Intensive weighting of petroleum drilling muds with galena, Transactions of the AIME, 127, 1937, 263-273; Onu, O. V., et al., Antimony sulphide (stibnite) and potash as local substitute to barite and lignosulfonate as drilling mud weighting additives, SPE Nigeria Annual International Conference and Exhibition, 1, 2014, 700-712; Gadalla, A., et al., High-density fluids customization and field application in Khursaniyah challenging wells, SPE Middle East Oil and Gas Show and Conference (MEOS) Proceedings, 2017, 1073-1088; and Basfar, S., et al., Prevention of hematite settling using perlite in water-based drilling fluid, Journal of Petroleum Science and Engineering, 210, 2021, 110030]. Many of these materials present drawbacks, such as higher material costs, increased abrasiveness leading to accelerated equipment wear, difficulty in filter cake removal, hydrophobic surface behavior, and overall operational inefficiencies [Al Jaberi, J., et al., Primary investigation of barite-weighted water-based drilling fluid properties, ACS Omega, 2022, 10.1021/acsomega.2c06264; and Aljaberi, J., et al., Primary investigation of ilmenite dosage effect on the water-based drilling fluid properties, Journal of Energy Resources Technology, 145, 2023, 1-11]. As a result, these alternatives have not achieved widespread adoption, and the industry continues to face a shortage of economical and effective weighting materials capable of meeting modern drilling demands.

Rapid growth in industrial activities has led to the generation of large quantities of by-products and waste materials, which pose challenges related to environmental pollution, contamination, and waste management. Identifying value-added applications for such industrial by-products offers an opportunity to address both environmental and economic concerns. One example includes utilization of red mud and similar industrial residues as drilling fluid and cement additives [Dodoo-Arhin, D., et al., Awaso bauxite red mud-cement based composites: characterisation for pavement applications, Case Studies in Construction Materials, 7, 2017, 45-55; AlBoraikan, R., et al., Innovative applications of red mud: converting an environmental challenge to a drilling asset, ACS Omega, 2022, 10.1021/acsomega.2c05755; and AlBoraikan, R., et al., The influence of red mud additive on drilling fluid performance: comparison between calcite in conventional drilling mud and red mud additive, International Petroleum Technology Conference (IPTC) Proceedings, 2024, IPTC-24174-MS]. Despite such efforts, there remains a continued need for novel, cost-effective, and environmentally sustainable materials that can address the growing demand for drilling and cementing additives, particularly weighting materials, under increasingly challenging wellbore conditions.

There is a need to develop cost-effective and environmentally sustainable solutions that can improve drilling and cementing in subterranean formations while overcoming temperature limitations and corrosivity issues associated with existing chemical and thermochemical methods. Accordingly, an aspect of the current disclosure is to provide a fluid including a heavy agent steel production byproduct and introducing the fluid into a subterranean formation as densifying and bridging materials for deep and ultra-deep well applications to overcome drawback and limitations of cementing agents known in the art.

### SUMMARY

In an exemplary embodiment, a method is described. The method includes providing a fluid including a heavy agent steel production byproduct. The heavy agent steel production byproduct includes calcium in an amount of 10 to 50 percent by weight (wt. %), iron in an amount of 8 to 25 wt. %, aluminum in an amount of 2 to 5 wt. %, magnesium in an amount of 1 to 5 wt. %, and silicon in an amount of 1 to 4 wt. % based on a total weight of the heavy agent steel production byproduct. The heavy agent steel production byproduct has a particle size distribution D₅₀ value of 10 to 110 μm. The method further includes introducing the fluid into a subterranean formation through tubing disposed in a well bore.

In some embodiments, the fluid has a plastic viscosity of 11.9 to 12.1 cP.

In some embodiments, the fluid has a plastic viscosity of 12 to 12.4 cP and the heavy agent steel production byproduct has a bimodal particle size distribution with a first particle size of from 5 to 10 μm and a second particle size of from 60 to 80 μm and a D₅₀ value of 10 to 20 μm.

In some embodiments, the fluid has a yield point of 10 to 14 lbs/100 ft².

In some embodiments, the fluid has a yield point of 9 to 13 lbs/100 ft².

In some embodiments, the fluid has a ten-second gel strength of 1 to 3 lbs per 100 ft².

In some embodiments, the fluid has a ten-second gel strength of 1.5 to 3 lbs per 100 ft².

In some embodiments, the fluid has a ten-minute gel strength of 1.5 to 3 lbs per 100 ft².

In some embodiments, the fluid has a ten-minute gel strength of 3 to 4 lbs per 100 ft².

In some embodiments, the heavy agent steel production byproduct has a particle size distribution D₅₀ value of 100 to 105 μm.

In some embodiments, the heavy agent steel production byproduct has a particle size distribution D₅₀ value of 15 to 20 μm.

In some embodiments, the heavy agent steel production byproduct includes oxygen in an amount of 35 to 45 percent by weight (wt. %), carbon in an amount of 25 to 34 wt. %, calcium in an amount of 11 to 15 wt. %, iron in an amount of 8 to 10 wt. %, aluminum in an amount of 3 to 4 wt. %, magnesium in an amount of 2 to 3 wt. %, and silicon in an amount of 2 to 4 wt. % based on a total weight of the heavy agent steel production byproduct.

In some embodiments, the heavy agent steel production byproduct includes calcium in an amount of 45 to 50 percent by weight (wt. %), iron in an amount of 20 to 25 wt. %, sodium in an amount of 9 to 13 wt. %, zinc in an amount of 2 to 5 wt. %, aluminum in an amount of 3 to 4.5 wt. %, magnesium in an amount of 2 to 5 wt. %, silicon in an amount of 1 to 4 wt. %, potassium in an amount of 1.5 to 2 wt. %, chloride in an amount of 1 to 1.5 wt. %, sulfur in an amount of 0.5 to 1.5 wt. %, phosphorous in an amount of 0.1 to 0.3, and arsenic in an amount of 0.1 to 0.3 based on a total weight of the heavy agent steel production byproduct.

In some embodiments, the fluid has a density of 8 to 12 pounds per gallon (ppg).

In some embodiments, the fluid has a density of 9 to 12 ppg.

In some embodiments, the fluid includes the heavy agent steel production byproduct in an amount of 80 to 100 pounds.

In some embodiments, the fluid includes water in an amount of 330 to 370 pounds, a first viscosifier in an amount of 3 to 7 pounds, a second viscosifier in an amount of 0.1 to 1 pounds, salts in an amount of 15 to 30 pounds, and a filtration agent in an amount of 3 to 7 pounds.

In some embodiments, the method further includes curing the fluid in the subterranean formation and the curing includes reacting one or more cementitious materials present in the heavy agent steel production byproduct to form a hydrated product that is deposited in the subterranean formation and or is adhered to the subterranean formation.

In some embodiments, the curing occurs at a pressure of 10 to 20 psi.

In some embodiments, the curing occurs at a pressure of 40 to 70° C.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic flow chart of a method of using a heavy agent steel-production byproduct (HASPB) as a densifier and bridging material in subterranean formation fluids, according to certain embodiments.

FIG. 2A is an image of a heavy agent steel-production byproduct 1 (HASPB1) formulation, according to certain embodiments.

FIG. 2B is an image of a heavy agent steel-production byproduct 2 (HASPB2) formulation, according to certain embodiments.

FIG. 3A depicts X-ray fluorescence (XRF) spectra of HASPB1 and HASPB2 formulations, according to certain embodiments.

FIG. 3B is a scanning electron microscope (SEM) image of the HASPB1 formulation, according to certain embodiments.

FIG. 3C is SEM image of the HASPB2 formulation, according to certain embodiments.

FIG. 3D depicts particle size distribution (PDS) of HASPB1 and HASPB2 formulations, according to certain embodiments.

FIG. 4 is a graph depicting high-pressure high temperature (HPHT) filter press test results for a base formulation (without heavy agent steel production byproducts) and formulations including HASPB1 and HASPB2, according to certain embodiments.

FIG. 5A is a filter cake morphology formed after fluid loss testing for the HASPB1 formulation, according to certain embodiments.

FIG. 5B is a filter cake morphology formed after fluid loss testing for the HASPB2 formulation, according to certain embodiments.

FIG. 5C is a filter cake morphology formed after fluid loss testing for the base formulation, according to certain embodiments.

FIG. 6 illustrates rheological properties of the base formulation and formulations including HASPB1 and HASPB2, including plastic viscosity (PV), yield point (YP), ten-second gel strength, and ten-minute gel strength, according to certain embodiments.

### DETAILED DESCRIPTION

When describing the present disclosure, the terms used are to be construed in accordance with the following definitions, unless a context dictates otherwise.

Embodiments of the present disclosure will now be described more fully hereinafter with reference to the accompanying drawings wherever applicable, in that some, but not all, embodiments of the disclosure are shown.

In the drawings, reference numerals designate identical or corresponding parts throughout the several views. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

As used herein, the term “filter cake” refers to the layer of solid particles deposited on a permeable surface during introduction or filtration of a drilling fluid, which serves to reduce fluid invasion into subterranean formations.

As used herein, the term “subterranean formation” refers to any naturally occurring rock strata, reservoir, or sediment located beneath the earth's surface that may be penetrated or encountered during drilling operations.

Aspects of the present disclosure relate to drilling and cementing fluids for use in deep well operations in the oil and gas industry. In particular, the present disclosure provides methods and compositions that employ heavy agent steel production byproducts as alternatives to conventional weighting and bridging materials such as barite.

Traditional drilling and cementing operations rely heavily on barite to control fluid density, which prevents formation kicks and maintains wellbore stability in deep and high-pressure wells; however, achieving high fluid density using barite often requires high material loading, which can adversely affect rheological properties, increase plastic viscosity, and limit filtration performance.

In the present disclosure, two heavy agent steel production byproducts, referred to herein as HASPB1 and HASPB2, are incorporated into drilling and cementing fluids for deep well applications. The disclosed byproducts are capable of increasing fluid density efficiently, using lower concentrations than barite to achieve equivalent or improved density levels. Reduced solids loading favorably impacts rheological properties, particularly by reducing plastic viscosity, thereby improving fluid pumpability and circulation efficiency. HASPB1 and HASPB2 also function dually as weighting agents and bridging materials. Their particle size distributions and compositional characteristics enable effective pore bridging, improved filtration control, and the formation of thin, stable filter cakes. Under high-pressure, high-temperature (HPHT) conditions, the disclosed fluids exhibit filtration volumes and filter cake thicknesses that are comparable to or better than conventional barite-based systems. Additional aspects of the present disclosure include environmentally sustainable drilling and cementing solutions derived from industrial steel production byproducts. The use of HASPB1 and HASPB2 reduces waste sent to landfills, lowers material costs, and provides a performance-enhancing alternative that aligns with the oil and gas industry's increasing emphasis on sustainability and operational efficiency. Aspects of the present disclosure provide cost-effective, high-performance, and environmentally responsible drilling and cementing compositions and methods suitable for deep well and HPHT applications.

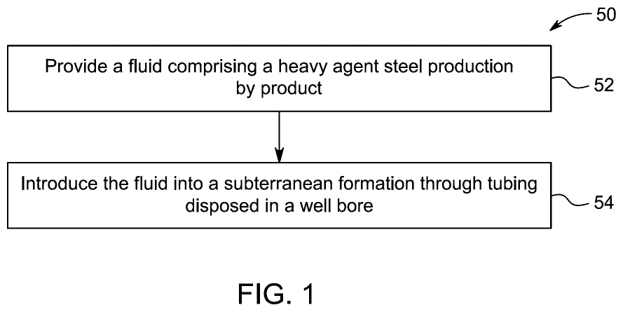

FIG. 1 illustrates a flow chart of a method 50. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes providing a fluid including a heavy agent steel production byproduct. The heavy agent steel production byproduct is derived from industrial steel-manufacturing processes and is recovered as a solid byproduct at one or more stages of steel production. The byproduct may be subjected to comminution, milling, or classification prior to use in the fluid to obtain a target particle size distribution. The heavy agent steel production byproduct includes calcium in an amount of 10 to 50 percent by weight (wt. %), preferably 15 to 45 wt. %, preferably 20 to 40 wt. %, and preferably 25 to 35 wt. %, iron in an amount of 8 to 25 wt. %, preferably 10 to 23 wt. %, preferably 12 to 21 wt. %, preferably 14 to 19 wt. %, and preferably 16 to 17 wt. %, aluminum in an amount of 2 to 5 wt. %, preferably 2.5 to 4.5 wt. %, and preferably 3 to 4 wt. %, magnesium in an amount of 1 to 5 wt. %, preferably 1.5 to 4.5 wt. %, preferably 2 to 4 wt. %, and preferably 2.5 to 3.5 wt. %, and silicon in an amount of 1 to 4 wt. %, preferably 1.5 to 3.5 wt. %, and preferably 2 to 3 wt. % based on the total weight of the byproduct. These compositional ranges enable the byproduct to act as a high-density particulate material while also providing surface chemistry conducive to fluid stability and filter cake formation.

In some embodiments, the heavy agent steel production byproduct includes oxygen in an amount of 35 to 45 wt. %, preferably 36 to 44 wt. %, preferably 37 to 43 wt. %, preferably 38 to 42 wt. %, and preferably 39 to 41 wt. %, carbon in an amount of 25 to 34 wt. %, preferably 26 to 33 wt. %, preferably 27 to 32 wt. %, preferably 28 to 31 wt. %, and preferably 29 to 30 wt. %, calcium in an amount of 11 to 15 wt. %, preferably 11.5 to 14.5 wt. %, preferably 12 to 14 wt. %, and preferably 12.5 to 13.5 wt. %, iron in an amount of 8 to 10 wt. % and preferably 8.5 to 9.5 wt. %, aluminum in an amount of 3 to 4 wt. %, preferably 3.2 to 3.8 wt. %, and preferably 3.4 to 3.6 wt. %, magnesium in an amount of 2 to 3 wt. %, preferably 2.2 to 2.8 wt. %, and preferably 2.4 to 2.6 wt. %, and silicon in an amount of 2 to 4 wt. %, preferably 2.2 to 3.8 wt. %, preferably 2.4 to 3.6 wt. %, preferably 2.6 to 3.4 wt. %, and preferably 3.8 to 3.2 wt. % based on a total weight of the heavy agent steel production byproduct. In a preferred embodiment, the heavy agent steel production byproduct includes oxygen in an amount of about 39.4 wt. %, carbon in an amount of about 29.2 wt. %, calcium in an amount of about 13.3 wt. %, iron in an amount of about 9.2 wt. %, aluminum in an amount of about 3.4 wt. %, magnesium in an amount of about 2.6 wt. %, and silicon in an amount of about 2.9 wt. % based on a total weight of the heavy agent steel production byproduct.

In another embodiment, the heavy agent steel production byproduct includes calcium in an amount of 45 to 50 wt. %, preferably 46 to 49 wt. %, and preferably 47 to 48 wt. %, iron in an amount of 20 to 25 wt. %, preferably 21 to 24 wt. %, and preferably 22 to 23 wt. %, sodium in an amount of 9 to 13 wt. %, preferably 9.5 to 12.5 wt. %, preferably 10 to 12 wt. %, and preferably 10.5 to 11.5 wt. %, zinc in an amount of 2 to 5 wt. %, preferably 2.5 to 4.5 wt. %, and preferably 3 to 4 wt. %, aluminum in an amount of 3 to 4.5 wt. % and preferably 3.5 to 4 wt. %, magnesium in an amount of 2 to 5 wt. %, preferably 2.5 to 4.5 wt. %, and preferably 3 to 4 wt. %, silicon in an amount of 1 to 4 wt. %, preferably 1.5 to 3.5 wt. %, and preferably 2 to 3 wt. %, potassium in an amount of 1.5 to 2 wt. %, preferably 1.6 to 1.9 wt. %, and preferably 1.7 to 1.8 wt. %, chloride in an amount of 1 to 1.5 wt. %, preferably 1.1 to 1.4 wt. %, and preferably 1.2 to 1.3 wt. %, sulfur in an amount of 0.5 to 1.5 wt. %, preferably 0.7 to 1.3 wt. %, and preferably 0.9 to 1.1 wt. %, phosphorous in an amount of 0.1 to 0.3 wt. % and preferably 0.15 to 0.25 wt. %, and arsenic in an amount of 0.1 to 0.3 wt. % and preferably 0.15 to 0.25 wt. % based on the total weight of the heavy agent steel production byproduct. In another preferred embodiment, the heavy agent steel production byproduct includes calcium in an amount of about 47.7 wt. %, iron in an amount of about 23.3 wt. %, sodium in an amount of about 11 wt. %, zinc in an amount of about 4 wt. %, magnesium in an amount of about 3.4 wt. %, aluminum in an amount of about 3.7 wt. %, silicon in an amount of about 2.4 wt. %, chloride in an amount about 1.2 wt. %, potassium in an amount of about 1.7 wt. %, sulfur in an amount of about 1 wt. %, arsenic in an amount of about 0.2 wt. %, and phosphorous in an amount of about 0.2 wt. % based on based on the total weight of the heavy agent steel production byproduct. Multi-component compositions provide enhanced density and bridging performance under downhole conditions.

The heavy agent steel production byproduct exhibits a particle size distribution characterized by a median particle diameter (D₅₀) of 10 to 110 μm, preferably 15 to 105 μm, preferably 20 to 100 μm, preferably 25 to 95 μm, preferably 30 to 90 μm, preferably 35 to 85 μm, preferably 40 to 80 μm, preferably 45 to 75 μm, preferably 50 to 70 μm, and preferably 55 to 65 μm. This particle size range allows the heavy agent steel production byproduct to simultaneously function as a weighting agent and a bridging agent within the fluid.

In one embodiment, the heavy agent steel production byproduct has a D₅₀ value of 100 to 105 μm, preferably 100.5 to 104.5 μm, preferably 101 to 104 μm, preferably 101.5 to 103.5 μm, more preferably 102 to 103 μm, and yet more preferably about 102 μm. In another embodiment, the heavy agent steel production byproduct has a D₅₀ value of 15 to 20 μm, preferably 15.5 to 19.5 μm, preferably 16 to 19 μm, preferably 16.5 to 18.5 μm, more preferably 17 to 18 μm, and yet more preferably about 17 μm. In an embodiment, the particle size distribution D₅₀ value may enhance suspension stability and filtration control of the fluid.

In some embodiments, the fluid includes water as a continuous phase and the heavy agent steel production byproduct dispersed therein. In some embodiments, the fluid includes the heavy agent steel production byproduct in an amount of 80 to 100 pounds, preferably 82 to 98 pounds, preferably 84 to 96 pounds, preferably 86 to 94 pounds, more preferably 88 to 92 pounds, and yet more preferably about 90 pounds. In one embodiment, the fluid includes the heavy agent steel production byproduct in an amount of about 90 pounds per barrel or per batch of fluid depending on the desired fluid density.

In some embodiments, the fluid includes water in an amount of 330 to 370 pounds, preferably 335 to 365 pounds, preferably 340 to 360 pounds, and preferably 245 to 355 pounds, a first viscosifier (e.g., a clay-based viscosifier) in an amount of 3 to 7 pounds, preferably 3.5 to 6.5 pounds, preferably 4 to 6 pounds, and preferably 4.5 to 5.5 pounds, a second viscosifier (e.g., a polymer-based viscosifier) in an amount of 0.1 to 1 pound, preferably 0.2 to 0.8 pounds, and preferably 0.4 to 0.6 pounds, salts in an amount of 15 to 30 pounds, preferably 17 to 28 pounds, preferably about 19 to 26 pounds, and preferably 21 to 24 pounds, and a filtration agent in an amount of 3 to 7 pounds, preferably about 3.5 to 6.5 pounds, preferably 4 to 6 pounds, and preferably 4.5 to 5.5 pounds. In some embodiments, the fluid further includes one or more viscosifiers, salts, and filtration agents. The additives contribute to rheological control, shale inhibition, pH management, and filtration performance.

In some embodiments, the salts include, but are not limited to, lithium salts, sodium salts, magnesium salts, aluminum salts, potassium salts, calcium salts, manganese salts, iron salts, cobalt salts, nickel salts, copper salts, zinc salts, a combination thereof, and the like. In other embodiments, the salts include, but are not limited to, fluoride salts, chloride salts, bromide salts, iodide salts, nitrate salts, nitrite salts, carbonate salts, bicarbonate salts, sulfate salts, sulfite salts, phosphate salts, phosphite salts, a combination thereof, and the like.

In certain embodiments, the fluid has a plastic viscosity of 11.9 to 12.1 cP, preferably 11.92 to 12.08 cP, preferably 11.94 to 12.06 cP, preferably 11.96 to 12.04 cP, more preferably 11.98 to 12.02 cP, and yet more preferably about 12.01 cP. In another embodiment, the fluid has a plastic viscosity of 12 to 12.4 cP, preferably 12.05 to 12.35 cP, preferably 12.1 to 12.3 cP, more preferably 12.15 to 12.25 cP, and yet more preferably about 12.21 cP and the heavy agent steel byproduct has a bimodal particle size distribution with a first particle size of from 2 to 15 μm, preferably from 5 to 10 μm, preferably 6 to 9 μm, and preferably 7 to 8 μm and a second particle size of from 50 to 100 μm preferably 60 to 80 μm, preferably 62 to 78 μm, preferably 64 to 76 μm, preferably 66 to 74 μm, and preferably 68 to 72 μm and a D₅₀ value of 10 to 20 μm, preferably 11 to 19 μm, preferably 12 to 18 μm, preferably 13 to 17 μm, and preferably 14 to 16 μm.

In some embodiments, the fluid has a yield point of 10 to 14 lbs/100 ft², preferably 10.5 to 13.5 lbs/100 ft², preferably 11 to 13 lbs/100 ft², more preferably 11.5 to 12.5 lbs/100 ft², and yet more preferably about 12.11 lbs/100 ft². In another embodiment, the fluid has a yield point of 9 to 13 lbs/100 ft², preferably 10 to 12 lbs/100 ft², more preferably 10.5 to 11 lbs/100 ft², and yet more preferably about 10.76 lbs/100 ft². Such yield point values maintain suspensions of solids while avoiding excessive pump pressure.

In some embodiments, the fluid has a ten-second gel strength of 1 to 3 lbs/100 ft², preferably 1.2 to 2.5 lbs/100 ft², more preferably 1.4 to 2 lbs/100 ft², and yet more preferably about 1.46 lbs/100 ft². In an embodiment, the fluid includes the heavy agent steel production byproduct in an amount of about 130 pounds per barrel of water and has a ten-second gel strength of 1.46 lbs/100 ft². In other embodiments, the fluid exhibits a ten-second gel strength of 1.5 to 3 lbs/100 ft², preferably 2 to 2.5 lbs/100 ft², and more preferably about 2.31 lbs/100 ft². In another embodiment, the fluid includes the heavy agent steel production byproduct in an amount of about 130 pounds per barrel of water and has a ten-second gel strength of 2.31 lbs/100 ft².

In some embodiments, the fluid has a ten-minute gel strength of 1.5 to 3 lbs/100 ft², preferably 2 to 2.5 lbs/100 ft², and more preferably about 2.29 lbs/100 ft². In an embodiment, the fluid includes the heavy agent steel production byproduct in an amount of about 130 pounds per barrel of water and has a ten-minute gel strength of 2.29 lbs/100 ft². In other embodiments, the fluid has a ten-minute gel strength of 3 to 4 lbs/100 ft², preferably 3.2 to 3.8 lbs/100 ft², more preferably 3.4 to 3.6 lbs/100 ft², and yet more preferably about 3.52 lbs/100 ft². In another embodiment, the fluid includes the heavy agent steel production byproduct in an amount of about 130 pounds per barrel of water and has a ten-minute gel strength of 3.52 lbs/100 ft². These gel strength values enable rapid resuspension after static periods and reduce the risk of barite or solids sag.

In some embodiments, the fluid has a density of 8 to 12 pounds per gallon (ppg), preferably 8.5 to 11.5 ppg, preferably 9 to 11 ppg, more preferably 9.5 to 10.5 ppg, and yet more preferably about 10 ppg. In other embodiments, the fluid has a density of 9 to 12 ppg, preferably 9.5 to 11.5 ppg, more preferably 10 to 11 ppg, and yet more preferably about 10.5 ppg. The reduced mass loading used to reach a density, relative to conventional barite systems, contributes to improved rheological performance.

At step 54, the method 50 includes introducing the fluid into a subterranean formation through tubing disposed in a wellbore. In one or more embodiments, the wellbore may be present in an oil well, a gas well, a production well, an injection well, a naturally flowing well, an artificially lifted well, a high-temperature well, a steam-assisted gravity drainage well, a steam injector well, a geothermal well, a combination thereof, and the like. The wellbore may be formed in the subterranean geologic formation by known techniques. The subterranean geological formation may include, but is not limited to, a depleted oil reservoir, a depleted gas reservoir, a sour reservoir, a hydrocarbon-bearing subterranean formation, a saline formation, an un-minable coal bed, a combination thereof, and the like. The tubing may include, but is not limited to, drill pipe, production tubing, casing, liners, coiled tubing, combinations thereof, and the like. The fluid may be circulated or placed within the wellbore to facilitate drilling, wellbore stabilization, or formation isolation.

In some embodiments, the method further includes curing the fluid in the subterranean formation. In some embodiments, the curing includes reacting one or more cementitious materials present in the heavy agent steel production byproduct to form a hydrated product that is deposited in the subterranean formation and or is adhered to the subterranean formation. In some embodiments, curing the fluid in the subterranean formation includes wet curing. In some embodiments, curing the fluid forms a hydraulic cement in the subterranean formation. In some embodiments, the hydraulic cement includes heavy agent steel production byproduct comprising one or more of alite, belite, tricalcium aluminate, brownmillerite, a combination thereof, and the like, as a cementitious material. In some embodiments, curing the fluid includes chemically hydrating one or more of the cementitious materials in the heavy agent steel production byproduct thereby forming a corresponding hydrate. In some embodiments, the curing forms a hydrated material in the subterranean formation. In other embodiments, the curing forms a hydrated cementitious material disposed in the wellbore in the subterranean formation. In some embodiments, the curing forms a calcium silicate hydrate. In some embodiments, the curing includes hydrating alite (3CaO·SiO₂), belite (2CaO·SiO₂), tricalcium aluminate (3CaO·Al₂O₃), brownmillerite (4CaO·Al₂O₃·Fe₂O₃), and/or calcium silicate hydrate (CaSH). In an embodiment, the curing forms a hardened cement paste in the subterranean formation, e.g., in pores and fissures of the subterranean formation. In some embodiments, the curing may occur as the fluid is exposed to downhole pressure and temperature conditions. In some embodiments, the curing occurs at a pressure of 10 to 20 psi, preferably 11 to 19 psi, preferably 12 to 18 psi, preferably 13 to 17 psi, more preferably 14 to 16 psi, and yet more preferably about 15 psi. In some embodiments, the curing occurs at a substantially elevated pressure of 500 to 10,000 to 20 psi, preferably 1,000 to 5,000 psi, preferably 2,000 to 3,000. In another embodiment, the curing occurs at a temperature of 40 to 70° C., preferably 45 to 65° C., preferably 50 to 60° C., and preferably about 55° C. Such curing conditions may promote consolidation of the filter cake or stabilization of the fluid structure within the formation. In another embodiment, the curing occurs at a substantially elevated down hole temperature of 75 to 150° C., preferably 100 to 125° C. Such curing conditions may promote consolidation of the filter cake or stabilization of the fluid structure within the formation.

### EXAMPLES

The following examples describe and demonstrate methods of using heavy agent steel-production byproducts (HASPBs) in subterranean formation fluids. The examples are provided solely for illustration and are not to be construed as limitations of the present disclosure, as many variations thereof are possible without departing from the spirit and scope of the present disclosure.

### Example 1: Materials and Methods

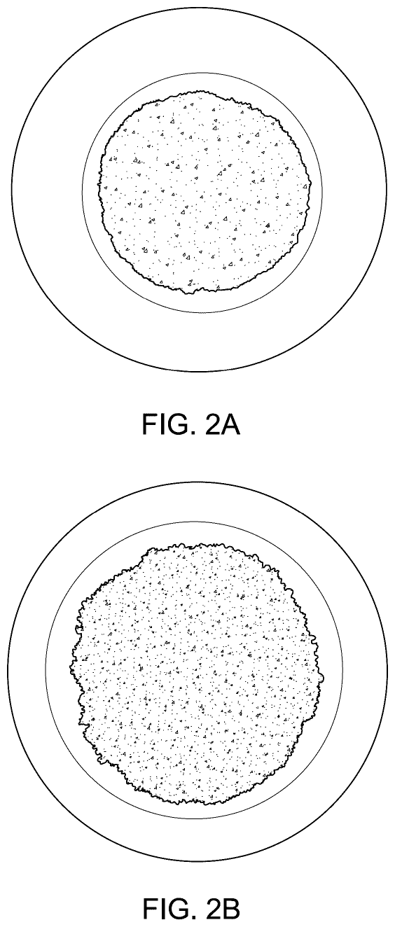

Heavy agent steel-production byproducts, namely HASPB1 and HASPB2, were collected from an industrial steel manufacturing facility at different stages of the steel-production process as by-products. Optical images of HASPB1 and HASPB2 are shown in FIG. 2A and FIG. 2B, respectively. These byproducts are inexpensive, readily available in large quantities, and are generated in volumes that frequently exceed conventional recycling and reuse capacities, resulting in landfill disposal despite their metal content.

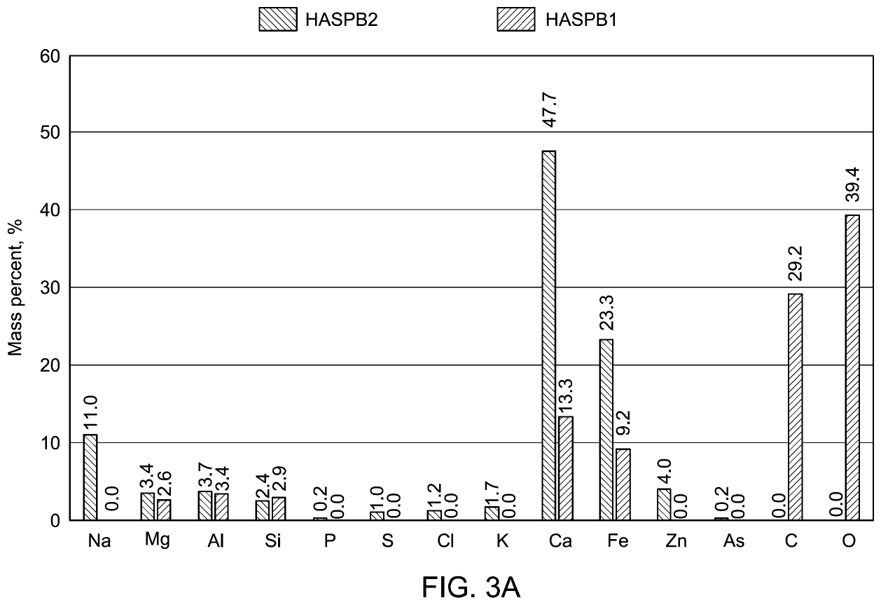

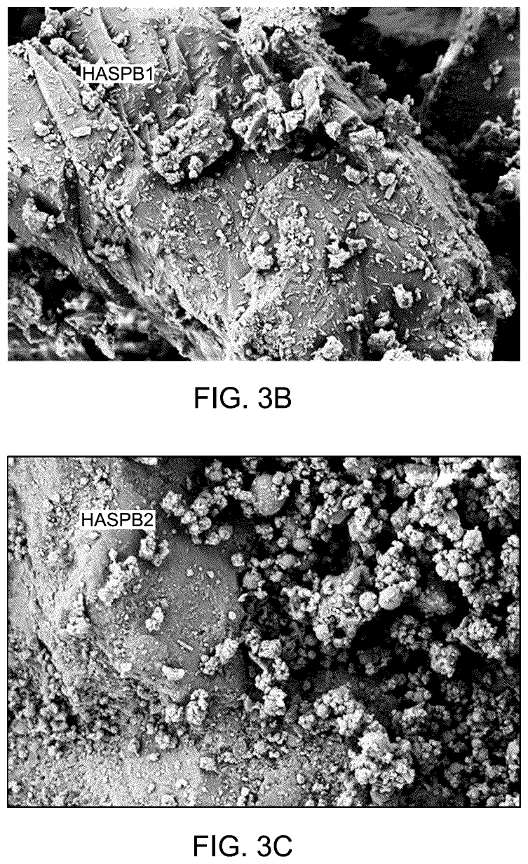

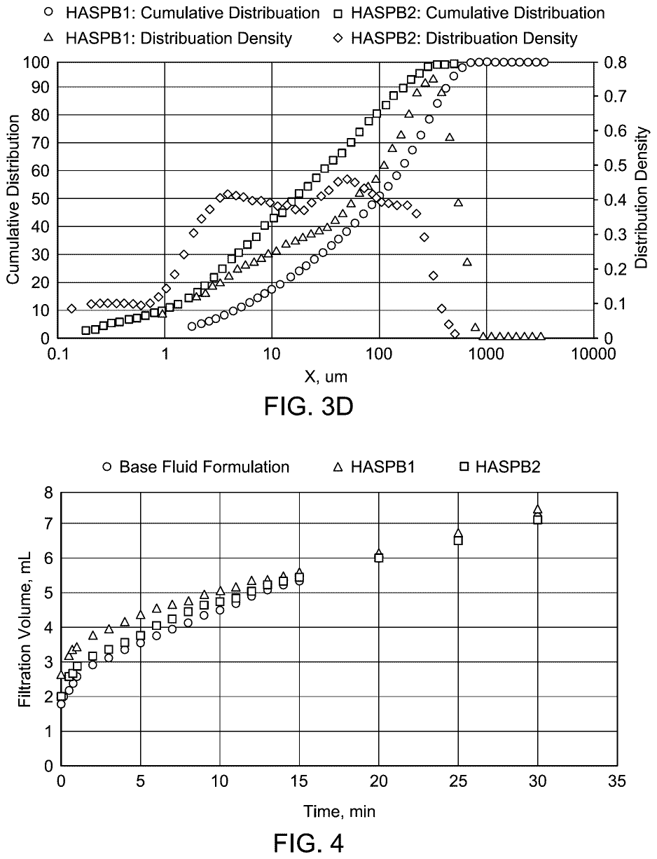

Prior to characterization, HASPB1 and HASPB2 were milled to obtain representative particle sizes. The milled materials were characterized using X-ray fluorescence (XRF), scanning electron microscopy (SEM), and particle size distribution (PSD) analysis. The characterization results are presented in FIGS. 3A-3D.

XRF analysis (FIG. 3A) revealed that HASPB1 consisted primarily of oxygen, carbon, and iron. HASPB2 consisted mainly of calcium, iron, and sodium, as shown in FIG. 3A. SEM images indicated that both HASPB1 and HASPB2 exhibited irregular particle morphologies, as illustrated in FIG. 3B and FIG. 3C, respectively. Particle size distribution analysis demonstrated that the median particle size (D₅₀) of HASPB1 was 102 μm, while the D₅₀ of HASPB2 was 17 μm, as shown in FIG. 3D.

### Example 2: Testing Procedure and Performance Evaluation

To evaluate the performance of the present disclosure relative to conventional barite-based drilling mud systems, three drilling fluid formulations were prepared. Each formulation comprised water as a continuous phase and included at least one viscosifier, such as clay and polymer, to control fluid viscosity. Various salts were incorporated to prevent clay swelling, control pH, and maintain calcium ion concentration. A filtration agent was added to increase filtration behavior and filter-cake properties.

A difference among the three formulations was the selection of weighting and bridging materials. In the base formulation, barite was used as the weighting material and calcium carbonate was used as the bridging material. In the modified formulations, HASPB1 and HASPB2 were each used as both the weighting material and the bridging material. The concentration of each component in the formulations is summarized in Table 1.

TABLE 1
Mud Formulations

| Name | Unit | HASPB1 | HASPB2 | Base Fluid |
|---|---|---|---|---|
| Water | bbl. | 0.691 | | |
| Viscofier 1 | lbs. | 4 to 6 | | |
| Viscofier 2 | lbs. | 0.5 | | |
| Salts | lbs. | 20 to 25 | | |
| Filtration Agent | lbs. | 4 to 6 | | |
| HASPB1 | lbs. | 90 | NA | NA |
| HASPB2 | lbs. | NA | 90 | NA |
| Barite | lbs. | NA | NA | 102 |
| CaCO₃ | lbs. | NA | NA | 5 |

Several tests were conducted to assess drilling fluid performance, including density measurements, rheological measurements, and high-pressure high-temperature (HPHT) filtration tests. Density measurements were obtained using a mud balance under ambient conditions. Rheological properties, including plastic viscosity, yield point, and gel strength at 10 seconds and 10 minutes, were measured at a pressure of 14.7 psi and a temperature of 120° F. HPHT filtration tests were conducted using a 20-μm ceramic disk at a differential pressure of 300 psi and a temperature of 150° F. Following filtration, the resulting filter cakes were oven-dried, and the filter-cake thickness was measured using a caliper.

The test results demonstrated that the base drilling fluid achieved a density of 10.2 ppg using 102 lbs of barite. The HASPB1- and HASPB2-based formulations achieved a comparable density using only 90 lbs of weighting material. The reduced material concentration favorably impacted rheological performance, particularly plastic viscosity. As shown in FIG. 6, plastic viscosity decreased from 13.6 cP for the base formulation to 12.0 cP and 12.21 cP for the HASPB1 and HASPB2 formulations, respectively. Other rheological parameters remained within acceptable ranges comparable to those of the base drilling fluid.

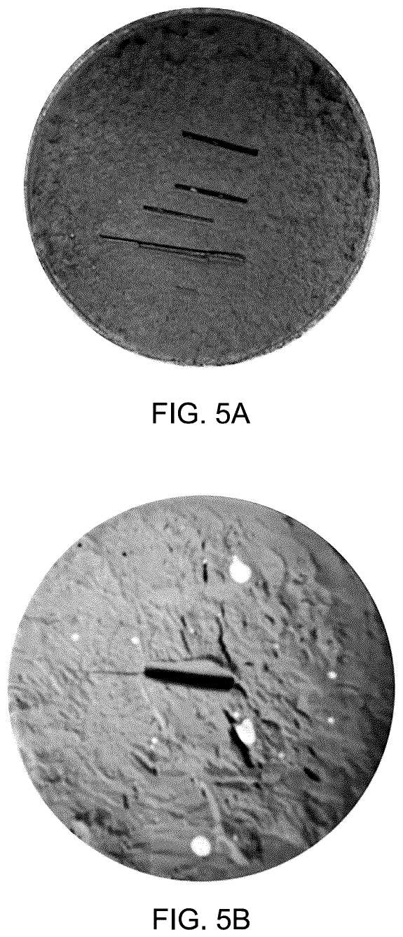

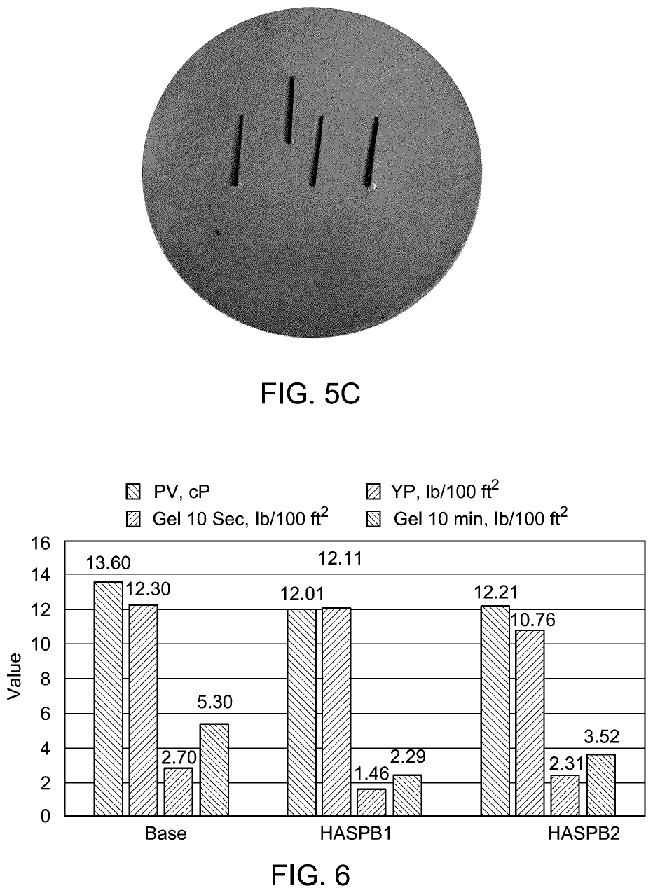

HPHT filtration results indicated that the final filtration volume and filter-cake thickness were similar across all formulations, as illustrated in FIG. 4 and FIGS. 5A-5C. Specifically, the final filtration volumes were 7.3 mL for the base formulation, 7.5 mL for the HASPB1 formulation, and 7.2 mL for the HASPB2 formulation. The corresponding filter-cake thicknesses were 1.59 mm, 1.59 mm, and 1.62 mm for the base, HASPB1, and HASPB2 formulations, respectively.

Numerous modifications and variations of the present disclosure are possible in light of the above teachings. It is therefore to be understood that within the scope of the appended claims, the disclosure may be practiced otherwise than as specifically described herein.

1: A method, comprising:
providing a fluid comprising a heavy agent steel production byproduct,
wherein the heavy agent steel production byproduct comprises calcium in an amount of 10 to 50 percent by weight (wt. %), iron in an amount of 8 to 25 wt. %, aluminum in an amount of 2 to 5 wt. %, magnesium in an amount of 1 to 5 wt. %, and silicon in an amount of 1 to 4 wt. % based on a total weight of the heavy agent steel production byproduct,
wherein the heavy agent steel production byproduct has a particle size distribution D₅₀ value of 10 to 110 μm, and
introducing the fluid into a subterranean formation through tubing disposed in a wellbore.

2: The method of claim 1, wherein the fluid has a plastic viscosity of 11.9 to 12.1 cP.

3: The method of claim 1, wherein the fluid has a plastic viscosity of 12 to 12.4 cP, wherein the heavy agent steel production byproduct has a bimodal particle size distribution with a first particle size of from 5 to 10 μm and a second particle size of from 60 to 80 μm and a D₅₀ value of 10 to 20 μm.

4: The method of claim 1, wherein the fluid has a yield point of 10 to 14 lbs/100 ft².

5: The method of claim 1, wherein the fluid has a yield point of 9 to 13 lbs/100 ft².

6: The method of claim 1, wherein the fluid has a ten-second gel strength of 1 to 3 lbs per 100 ft².

7: The method of claim 1, wherein the fluid has a ten-second gel strength of 1.5 to 3 lbs per 100 ft².

8: The method of claim 1, wherein the fluid has a ten-minute gel strength of 1.5 to 3 lbs per 100 ft².

9: The method of claim 1, wherein the fluid has a ten-minute gel strength of 3 to 4 lbs per 100 ft².

10: The method of claim 1, wherein the heavy agent steel production byproduct has a particle size distribution D₅₀ value of 100 to 105 μm.

11: The method of claim 1, wherein the heavy agent steel production byproduct has a particle size distribution D₅₀ value of 15 to 20 μm.

12: The method of claim 1, wherein the heavy agent steel production byproduct comprises oxygen in an amount of 35 to 45 percent by weight (wt. %), carbon in an amount of 25 to 34 wt. %, calcium in an amount of 11 to 15 wt. %, iron in an amount of 8 to 10 wt. %, aluminum in an amount of 3 to 4 wt. %, magnesium in an amount of 2 to 3 wt. %, and silicon in an amount of 2 to 4 wt. % based on a total weight of the heavy agent steel production byproduct.

13: The method of claim 1, wherein the heavy agent steel production byproduct comprises calcium in an amount of 45 to 50 percent by weight (wt. %), iron in an amount of 20 to 25 wt. %, sodium in an amount of 9 to 13 wt. %, zinc in an amount of 2 to 5 wt. %, aluminum in an amount of 3 to 4.5 wt. %, magnesium in an amount of 2 to 5 wt. %, silicon in an amount of 1 to 4 wt. %, potassium in an amount of 1.5 to 2 wt. %, chloride in an amount of 1 to 1.5 wt. %, sulfur in an amount of 0.5 to 1.5 wt. %, phosphorous in an amount of 0.1 to 0.3, and arsenic in an amount of 0.1 to 0.3 based on a total weight of the heavy agent steel production byproduct.

14: The method of claim 1, wherein the fluid has a density of 8 to 12 pounds per gallon (ppg).

15: The method of claim 1, wherein the fluid has a density of 9 to 12 ppg.

16: The method of claim 1, wherein the fluid comprises the heavy agent steel production byproduct in an amount of 80 to 100 pounds.

17: The method of claim 1, wherein the fluid comprises water in an amount of 330 to 370 pounds, a first viscosifier in an amount of 3 to 7 pounds, a second viscosifier in an amount of 0.1 to 1 pounds, salts in an amount of 15 to 30 pounds, and a filtration agent in an amount of 3 to 7 pounds.

18: The method of claim 1, further comprising:
curing the fluid in the subterranean formation,
wherein curing includes reacting one or more cementitious materials present in the heavy agent steel production byproduct to form a hydrated product that is deposited in the subterranean formation and or is adhered to the subterranean formation.

19: The method of claim 18, wherein the curing occurs at a pressure of 10 to 20 psi.

20: The method of claim 18, wherein the curing occurs at a temperature of 40 to 70° C.
